(19) United States
(12) Patent Application Publication
(10) Pub. No.: US 2025/0350361 A1
(43) Pub. Date: Nov. 13, 2025

(54) LENS MODULE, OPTICAL WIRELESS TRANSCEIVER AND OPTICAL WIRELESS SYSTEM

(71) Applicant: Fraunhofer-Gesellschaft zur Förderung der angewandten Forschung e.V., München (DE)

(72) Inventors: Tobias SCHNEIDER, Dresden (DE); René KIRRBACH, Dresden (DE)

(21) Appl. No.: 19/276,528

(22) Filed: Jul. 22, 2025

Related U.S. Application Data
(63) Continuation of application No. PCT/EP2024/051282, filed on Jan. 19, 2024.

(30) Foreign Application Priority Data
Jan. 23, 2023 (DE) 10 2023 200 482.8
May 11, 2023 (DE) 10 2023 204 393.9

(51) Int. Cl. H04B 10/114; G02B 3/08; G02B 17/08; H04B 10/40

(52) U.S. Cl. CPC H04B 10/1143; G02B 3/08; G02B 17/0856; H04B 10/40

(57) ABSTRACT

A lens module has a first surface and a second surface inclined relative to the first surface, which are optically coupled to each other via a third surface inclined relative to the first surface and the second surface. Each of the first surface, the second surface and the third surface has a first surface section and a second surface section, wherein the first surface sections are associated to one another and the second surface sections are associated to one another and form a respective optical arrangement.

### CROSS-REFERENCE TO RELATED APPLICATIONS

This application is a continuation of copending International Application No. PCT/EP2024/051282, filed Jan. 19, 2024, which is incorporated herein by reference in its entirety, and additionally claims priority from German Application No. 10 2023 200 482.8, filed Jan. 23, 2023, and from German Application No. 10 2023 204 393.9, filed May 11, 2023, which are also incorporated herein by reference in their entirety.

### TECHNICAL FIELD

The present invention relates to a lens module for directional deflection of optical-wireless signals, to an optical-wireless transceiver having such a lens module and to an optical-wireless system having an optical-wireless transceiver described herein.

### BACKGROUND OF THE INVENTION

The present invention relates in particular to providing optical-wireless communication in rotating systems having angled lens modules and to transceivers having an internal deflection surface which provides total reflection. Thus, the invention also relates to an optical design for a rotatable optical short-range transceiver for optical-wireless or optical-cordless data transmission according to the principle of deflection by reflection.

A typical optical data link consists of two optical-cordless transceivers. Such a scenario is illustrated by way of example in FIG. 8A and in FIG. 8B. The transceivers 1000₁ and 1000₂ each contain a transmitting unit TX 1002₁ and 1002₂ and a receiving unit RX 1004₁ and 1004₂, respectively. Thus, a transmitting unit is typically always positioned opposite a receiving unit, as illustrated in FIG. 8A with the notation rotation 0°. A respective transmitting beam 1006₁ and 1006₂ strikes the receiver 1002₂ and 1002₁, respectively, making the data link work. However, if the transceiver rotates by 180° about an axis of rotation 1008, as illustrated in FIG. 8B, the visual contact is lost and the data link is interrupted. The problem occurs in particular when the distance between two transceivers is of the order of magnitude of the transceiver size.

In the illustrated rotation of a conventional cordless transceiver, FIG. 8A shows a 0° starting position, in which the data link is intact, and FIG. 8B shows a state after 180° rotation, in which the data link is interrupted, since there is no longer any mutual visual contact.

A further problem is that the transceivers are usually designed such that they radiate perpendicularly from the substrate surface/circuit board surface along the surface normal. In order, for example, to radiate tangentially along the surface, an additional reflector is used or the component has to be placed obliquely in a complicated manner. Typical application examples are circuit boards, printed circuit boards (PCB), data links, an optical slip ring replacement on rotating machine parts or the like. Thus, the transceiver is arranged on the axis of rotation. For galvanic coupling on a circuit board, for example, communication is tangential to the circuit board surface, for instance for high-speed optocouplers.

Independently of this, a transceiver link in optical-wireless or optical-cordless data transmission has a transmitting unit 1002 with a light source. The radiating profile can be shaped with the transmitting optics. At the same time, a transceiver has a receiving unit 1004 with a photodiode, which in turn can have its own receiving optics in order to collect the light signal. These two elementary components are generally arranged next to each other. If the distance between the two transceivers is small compared to the size of the transceivers, they cannot be rotated with respect to each other about the optical axis without the transmission being interrupted since transmitter and receiver are no longer opposite each other, as illustrated referring to FIG. 8B. In addition, the radiating angle and receiving angle are limited along the preferred direction of the circuit board or substrate.

There is need for optical-wireless data links or connections, which enable rotation of two transceivers with respect to each other, offering low additional expenditure compared to existing solutions and furthermore offering a high degree of adjustability.

An object of the present invention is therefore to provide a lens module, an optical-wireless transceiver and an optical-wireless system enabling rotation of transceivers with respect to one another, offering low additional expenditure compared to known concepts and a high degree of adjustability with respect to optical-wireless signal guidance.

### SUMMARY

An embodiment may have a lens module having a first surface and a second surface inclined relative to the first surface, which are optically coupled to each other via a third surface inclined relative to the first surface and the second surface; wherein each of the first surface, the second surface and the third surface has a first surface section and a second surface section; wherein the first surface sections are associated to one another; and wherein the second surface sections are associated to one another, and form a respective optical arrangement.

According to another embodiment, an optical-wireless transceiver may have: a lens module according to the invention as mentioned above; an optical receiver aligned with the second partial surface region of the first surface; and configured to receive a first optical-wireless signal, which arrives at the second partial surface region of the second surface, from the second partial surface region of the first surface; and an optical transmitter aligned with the first partial surface region of the first surface; and configured to transmit a second optical-wireless signal to the first partial surface region of the first surface; and the lens module is configured to direct and shape the second optical-wireless signal onto the first partial surface region of the second surface.

According to another embodiment, an optical-wireless system may have: a first optical-wireless transceiver according to the invention as mentioned above, configured to receive the first optical-wireless signal and to transmit the second optical-wireless signal; and a second optical-wireless transceiver according to the invention as mentioned above, configured to receive the second optical-wireless signal and to transmit the first optical-wireless signal.

A core idea of the present invention is having recognized that a lens module can be designed such that it performs deflection of a direction of the optical-wireless signals and that at least two beam paths of optical-wireless signals can be deflected by the lens module.

As a result, optics modified compared to optics already in use can be used with little expenditure, which at the same time offers a high degree of adjustability with respect to a deflection angle and can be designed on the basis thereof such that a rotation capability of a transceiver having a corresponding lens module is provided.

According to an embodiment, a lens module having a first surface and a second surface inclined with respect to the first surface is provided. The first surface and the second surface are optically coupled to each other via a third surface inclined with respect to the first surface and second surface. Each of the first, second and third surfaces has a respective first surface section and a second surface section. The first surface sections of the first, second and third surfaces are associated to one another and the second surface sections of the first, second and third surfaces are associated to one another and form a respective optical arrangement.

According to an embodiment, the lens module is configured to provide a light exit from the first surface section of the second surface on the basis of a light entry at the first surface section of the first surface by means of total reflection at the first surface section of the third surface, or vice versa. Alternatively or additionally, the lens module is configured to provide a light exit from the second surface section of the second surface on the basis of a light entry at the second surface section of the first surface by means of total reflection at the second surface section of the third surface, or vice versa. This enables full-duplex communication between two transceivers or data transmission via two optical-wireless channels operated in parallel but configured with low interference.

According to an embodiment, the first surface is a combinatorial lens surface of a first and a second lens. The second surface is a combinatorial lens surface of the first and second lens and the third surface is a combinatorial deflection surface of the first and second lens. A reflection surface is particularly suitable for implementing such a third surface. The combinatorial configuration of lens surfaces offers a space-saving possibility for arranging the optical emitters or detectors, while accepting the corresponding design expenditure.

According to an embodiment, the first surface is configured, in a transition region between the first surface section and the second surface section or within the first or second surface section, such that it has a discontinuous surface shape. Alternatively or additionally, the second surface has a discontinuous surface shape in a transition between the first surface section and the second surface section or within the first or second surface section. Alternatively or additionally, the third surface has a discontinuous surface shape in a transition between the first surface section and the second surface section or within the first or second surface section. The discontinuous surface shapes enable adapting the lens geometries to both optical-wireless transmission channels and at the same time the use of a common lens module.

According to an embodiment, the first surface section and the second surface section of the first surface are arranged laterally adjacent to each other. Alternatively or additionally, the second surface section of the second surface is arranged so as to enclose the first surface section of the second surface. Alternatively or additionally, the second surface section of the third surface is arranged so as to enclose the first surface section of the third surface. While the arrangement of the surface sections of the first surface laterally adjacent to one another enables a laterally adjacent arrangement of optical receivers and/or emitters, an enclosing arrangement of surface sections with respect to one another enables a high optical-wireless transmission quality to be provided during rotation.

According to an embodiment, the first surface section of the second surface is formed to be rotationally symmetrical about an axis of rotation and the second surface section of the second surface is formed to be rotationally symmetrical about the axis of rotation. This allows precise beam deflection during rotation of the lens module, for instance while it is installed in a transceiver.

According to an embodiment, the first surface, the second surface and the third surface are inclined with respect to one another in order to effect deflection of a main beam direction of a first optical arrangement of the lens module, in particular approximately at right angles, that is with a deflection angle of 90° within a tolerance range of +30°. The substantially right-angled deflection allows a precise arrangement of the components of different transceivers with respect to one another.

According to an embodiment, the first surface sections of the first, second and third surfaces form a first optical arrangement for a first beam shaping for a first optical channel. The second surface sections of the first, second and third surfaces combinatorially form a second optical arrangement for a second beam shaping for a second optical channel. The first beam shaping is independent of the second beam shaping. This allows an individual design of the beam-shaping optics of different optical channels in a module.

According to an embodiment, the first optical channel and the second optical channel are substantially free of channel crosstalk, which enables a high transmission quality.

According to an embodiment, the first optical channel and the second optical channel are arranged to be locally disjoint from each other at the first surface, the second surface and the third surface by means of the first surface sections and the second surface sections. The local separation allows a high degree of avoiding channel crosstalk.

According to an embodiment, the second surface section of the first surface is formed to be contiguous and the second surface section of the second surface has several locally disjoint sub-regions. The second surface section of the third surface is simultaneously formed to transform an optical signal between the contiguous second surface section of the first surface and the locally disjoint sub-regions of the second surface section of the second surface. Beam shaping transformed for this purpose for beam splitting into the locally disjoint sub-regions or merging into the contiguous region enables a high degree of flexibility in determining the directions of the optical-wireless channels.

According to an embodiment, each of the first, second and third surfaces has at least one respective third surface section, for instance to provide a third optical channel. The lens module effects individual beam shaping between the at least three optical channels. This allows a high degree of adaptation to the respective area of use.

According to an embodiment, the lens module is formed monolithically or integrally. This enables precise production of the lens module and precise operation.

According to an embodiment, the lens module is formed comprising a plastic material, advantageously a high-temperature plastic, which supports a reflow process. The material Sabic EXTEM™ has proven to be particularly suitable here. The use of such a suitable plastic material allows the lens module to be produced in a time-saving and cost-saving manner in injection molding. By supporting a reflow process, the lens module can also be used in automated soldering processes, which entails time saving and cost saving.

According to an embodiment, an optical-wireless transceiver is provided. The transceiver has a lens module described herein and is furthermore equipped with an optical receiver and an optical transmitter. The optical receiver is aligned with the second partial surface region of the first surface and is configured to receive a first optical-wireless signal, which arrives at the second partial surface region of the second surface, from the first partial surface region of the first surface. The optical transmitter is aligned with the first partial surface region of the first surface and is configured to transmit a second optical-wireless signal to the first partial surface region of the first surface. The lens module is configured to direct and shape the second optical signal onto the first partial surface region of the second surface. This enables optical-wireless transceivers of small overall size, which at the same time are well suited for rotating applications, in particular with respect to the deflection by the third surface of the lens module.

According to an embodiment, the optical receiver and the optical transmitter are arranged on a common substrate. The optical-wireless transceiver has a holding structure, which is arranged on the substrate and configured to hold the lens module with respect to the optical receiver and the optical transmitter. This allows a combinatorial alignment of the lens module with respect to the optical transmitter and the optical receiver, which is advantageously inexpensive.

According to an embodiment, a main reception direction for receiving the first optical signal and a transmission direction, which describes a main emission direction of the emitted second optical-wireless signal, are parallel to each other, which is advantageous in particular in two-sided point-to-point communication.

According to an embodiment, an optical-wireless system is provided, which has at least two of the optical-wireless transceivers described herein. The first optical-wireless transceiver is configured to receive the first optical-wireless signal and to transmit the second optical-wireless signal. Conversely, the second optical-wireless transceiver is configured to receive the second optical-wireless signal and to transmit the first optical-wireless signal.

According to an embodiment, the respective second sides of the lens modules of the optical-wireless transceivers face each other. This, and in particular in an arrangement in which the lenses are congruent in a projection into a common projection surface, enables a high data transmission quality in the case of rotation of the transceivers with respect to each other.

According to an embodiment, the first optical-wireless transceiver is configured to perform rotation with respect to the second optical-wireless transceiver about a transmission main direction along which the second optical-wireless signal is transmitted by the second side of the first lens module. Alternatively or additionally, the second optical-wireless transceiver is configured to perform rotation with respect to the first optical-wireless transceiver about a transmission main direction along which the first optical-wireless signal is transmitted by the second side of the second lens module. This means that one or both transceivers can be moved rotationally.

According to an embodiment, the optical-wireless system is configured for full-duplex communication between the first optical-wireless transceiver and the second optical-wireless transceiver. The lens modules of the optical-wireless transceivers are configured for optical separation of opposite optical-wireless signals.

### BRIEF DESCRIPTION OF THE DRAWINGS

Particularly advantageous embodiments of the present invention are explained below referring to the attached drawings, in which:

FIG. 1 is a schematic side sectional view of a lens module according to an embodiment;

FIG. 2 is a schematic side sectional view of a lens module according to an embodiment, as a part of an optical-wireless transceiver according to an embodiment;

FIG. 3 is a schematic side sectional view of an optical-wireless system with two optical-wireless transceivers according to an embodiment;

FIGS. 4A-C are schematic views of the optical-wireless transceiver from FIG. 2 from different directions according to an embodiment;

FIG. 4D is a comparison of the different viewing directions of FIGS. 4A-C;

FIGS. 5A-C are views, comparable to FIGS. 4A-C, of an optical-wireless transceiver according to an embodiment, in which two receiving optics are associated to an optical receiver;

FIGS. 6A-C are illustrations, comparable to FIGS. 4A-C and 5A-C, of an optical-wireless transceiver according to an embodiment, which has a lens module according to an embodiment, which allows a transmission signal to be divided into a plurality of partial signals;

FIG. 7 is a schematic perspective illustration of a mode of operation of a beam-dividing or beam-merging surface or partial surface region according to an embodiment; and

FIGS. 8A-B are schematic illustrations of a known data link.

### DETAILED DESCRIPTION OF THE INVENTION

Before embodiments of the present invention are explained in more detail below with reference to the drawings, it is pointed out that identical, functionally identical or identically acting elements, objects and/or structures are provided with the same reference signs in the different figures so that the description of these elements illustrated in different embodiments is interchangeable or can be applied to one another.

Embodiments described below are described in connection with a plurality of details. However, embodiments can also be implemented without these detailed features. Furthermore, for the sake of comprehensibility, embodiments are described using block diagrams as a replacement for a detailed illustration. Furthermore, details and/or features of individual embodiments can be readily combined with one another as long as not explicitly the contrary is described.

The following embodiments relate to optical-wireless signal transmission or data transmission. In the context of the embodiments described herein, this is also referred to as LiFi (light fidelity or light transfer). The term “LiFi” refers to the terms such as IrDA (Infrared Data Association) or OWC (optical wireless communication). This means that the terms “optical-wireless data transmission”, “optical-cordless data transmission” and “LiFi” are used synonymously. Optical-wireless data transmission is understood here to mean transmitting an electromagnetic signal through a free transmission medium, for example air or another gas or a fluid. For this purpose, for example, wavelengths in an ultraviolet (UV) range with at least 53 nm and the infrared range, for example at most 1550 nm, can be used, wherein other wavelengths are also possible, differing from wavelengths used for radio standards. Optical-wireless data transmission can also comprise the use of one or more light-conducting fibers, for instance by using, for an emitter and/or receiver, a fiber from which or into which a signal is coupled out/coupled in, wherein fiber-bound optical data transmission, which is implemented for example by means of optical waveguides or optical waveguide cables, is optional.

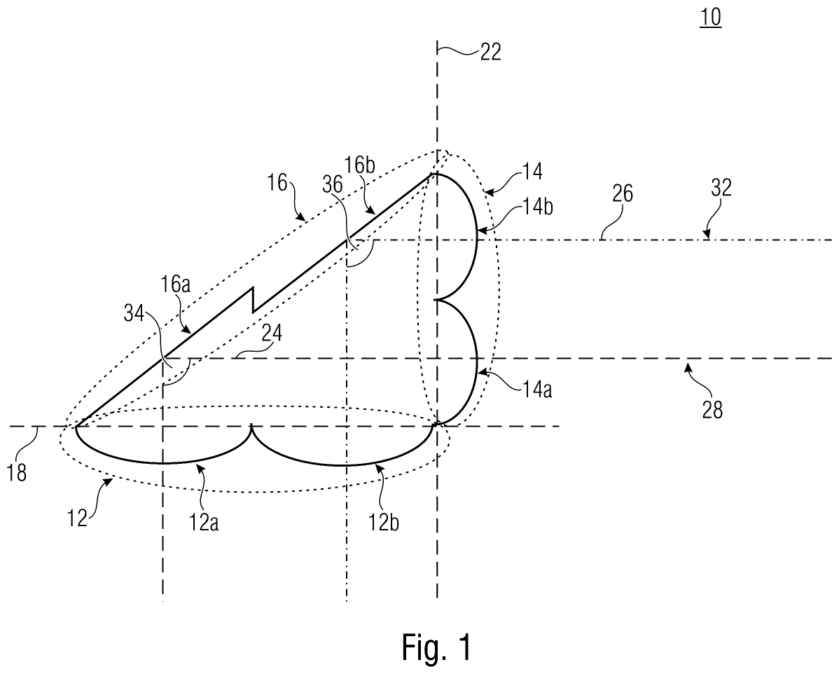

FIG. 1 shows a schematic side sectional view of a lens module 10 according to an embodiment. The lens module 10 comprises three surfaces 12, 14 and 16. Each of the surfaces 12, 14 and 16 comprises at least one first and one second surface section 12a and 12b, 14a and 14b and 16a and 16b, respectively. The surface sections of different surfaces 12, 14 and/or 16 can be formed continuously or discontinuously and/or be connected to one another continuously or discontinuously.

The lens module 10 can provide the function of a lens in which the surface 12 and the surface 14 can function, at least in a respective surface section, as an entry surface or exit surface of a respective optical channel.

The surfaces 12, 14 and 16 are illustrated to be exaggerated with respect to an uneven configuration. However, at least the first surface 12 and the second surface 14 can be understood such that they describe a surface plane 18 and 22, respectively, and are possibly formed unevenly with respect to the surface planes 18 and 22, respectively. The surface planes 18 and 22 can alternatively or additionally be understood such that they are perpendicular to the respective main viewing direction of optical channels. While a conventional lens can effect, for example, focusing or defocusing of light during passage of a light beam, the lens module 10 can furthermore effect significant deflection of the direction. This can be at least 20°, at least 30° or at least 45°, advantageously deflection of at least one main beam direction 24 and/or 26 of an optical arrangement of the lens module is effected by approximately 90° within a tolerance range of +30°, +20° or +10° or less.

The surface sections 16a and 16b of the surface 16 can optically couple the surfaces 12 and 14 to each other. Thus, the surface sections 16a and 16b can provide a deflection surface in order to deflect incident light which is incident from the side 12 or the side 14. Reflection surfaces are particularly suitable for this purpose, for example in order to effect total reflection. Compared with a conventional lens, directional deflection can thus additionally also be effected by means of a deflection surface. Conversely, if a prism or a beam splitter is used as comparison object, additional beam shaping can also be obtained by means of the sides 12 and/or 14. At the same time, due to the provided association of the respective surfaces 12a, 14a and 16a to one another, as well as the association of the surface sections 12b, 14b and 16b to one another to form a respective optical arrangement, independent optical channels 28 and 32 can be implemented, which can be independent of each other both in their direction along which light is sent through the lens module 10 and with respect to the implemented beam shaping.

Particularly in the case of a combination of different directions of optical channels 28 and 32 with respect to transmission signals and reception signals of a transceiver, which has such a lens module, a combined transmission-reception optics or transceiver optics can be implemented by the lens module 10, in contrast to pure transmission optics and pure reception optics.

Corresponding optical channels 28 and 32 are, for example, deflected via the main beam directions 24 and 26, which are deflected by means of the surface sections 16a and 16b with a deflection angle 34 for the optical channel 28 or with an angle 36 for the optical channel 32.

According to an embodiment, a light entry at a surface portion 12a or 12b of the surface 12 can be provided by means of total reflection at the associated surface section 16a or 16b of the surface 16, a light exit at the respectively associated surface section 14a or 14b, or vice versa. This can be understood as a passage of light from the side 12 to the side 14 or a passage of light from the side 14 to the side 12. As just mentioned, different optical channels 28 and 32 can be configured independent of each other with respect to beam-shaping properties and advantageous light flow directions.

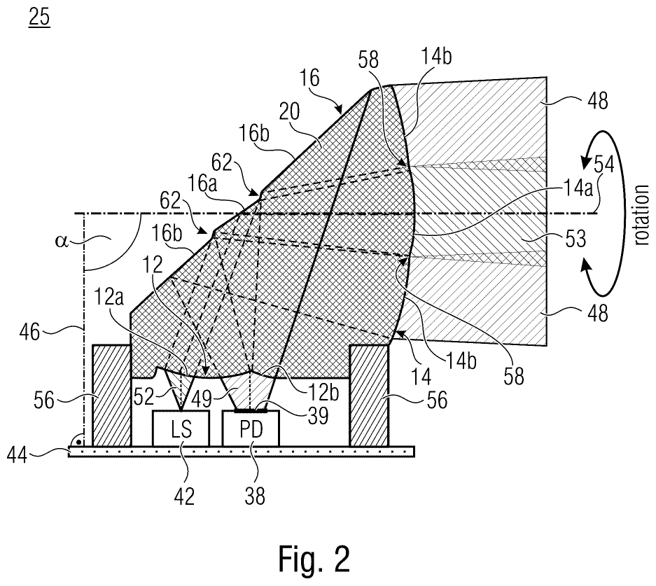

FIG. 2 shows a schematic side sectional view of a lens module 20 according to an embodiment. The lens module 20 can, for example, be part of an optical-wireless transceiver 25, of which at least parts are also shown. Thus, for example, an optical receiver 38, for instance a photodetector, PD, and an optical transmitter 42 (light source, LS) can be arranged on a common or individual substrate 44, for instance comprising a circuit board, printed circuit board, PCB.

The optical receiver 38 can optionally, just like the optical transmitter 42, have an active region 39 of the optical receiver. With respect to the active region, beam-shaping optics can optionally be arranged, for example to converge the emitter beam in advance and thus facilitate the design of the transceiver optics. Additional optics on the PD can likewise be expedient in order to maximize the optical conductance (etendue) of the entire optical receiver channel. A receiving angle of a possible photodetector can be close to 90°. Such an approach can be expediently realized within the scope of a semiconductor process, for instance in order to apply a silicon (Si) lens to a laser diode and/or photodiode.

The arrangement of optical receiver 38 and/or optical receiver 42 on the substrate 44, which can have a normal vector or a normal direction 46, can result in preferred directions of optical receiver 38 and/or optical transmitter 42 parallel to the normal direction 46. An orientation of the surface 16 or of the surface sections 16a and 16b can influence or determine an angle α with which the optical channels are deflected. Thus, for example, due to an association of the surface sections 12a, 14a and 16a to form an optical arrangement, a first optical channel can be formed, which is enclosed by a second optical channel beyond the side 14. For this purpose, for example, the surface section 14b can be arranged so as to enclose the surface section 14a of the surface 14. Alternatively, but advantageously combinatorially, the surface section 16b of the surface 16 is arranged so as to enclose the surface section 16a of the surface 16. Independently of this, but advantageously in combination, the surface sections 12a and 12b are arranged laterally adjacent to each other, which allows a laterally adjacent arrangement of optical receiver 38 and optical transmitter 42.

A first optical signal 48, for example a receiving beam directed onto the optical receiver 38, can be deflected independently, but also simultaneously, to form a second optical signal 52, for example a transmitting beam with the lens module 20. The exemplary transmitting signal 52 can be shaped by the lens module 20 to form a shaped transmitting signal 53; an exemplary received signal 48 can be shaped by the lens module 20 to form a shaped signal 49.

The configuration shown allows a symmetrical transmitting field and receiving field to be constructed with respect to a possible axis of rotation 54, while the field of view of the optical receiver 38, like the illuminated field of the optical transmitter 42, is tilted or even arranged perpendicular to the normal vector 46 in space. The axis 54 can also be understood, independently of the mechanical rotation, as a main reception direction for receiving an optical signal and/or as a main transmission direction or main emission direction of an emitted optical-wireless signal. The main reception direction and the main transmission direction can advantageously be parallel to each other and/or congruent.

According to an embodiment, in particular in the case of an optional arrangement of the optical receiver 38 and the optical transmitter 42 on a common substrate 44, a holding structure 56 can be arranged in the optical-wireless transceiver 25, for instance a frame, a holder or fastener or a spacer, wherein the fastening structure 56 can be arranged on the substrate 44 and can be configured to hold, that is to fix locally, the lens module, for instance the lens module 10 or 20, with respect to the optical receiver 38 and the optical transmitter 42.

Embodiments described herein can be implemented particularly advantageously if at least one, but also several or even all of the surfaces 12, 14 and/or 16 are formed discontinuously. Thus, for example, the surface 12 can have a discontinuous surface shape in a transition region between the surface section 12a and the surface section 12b or within the surface section 12a and/or 12b. This is illustrated by way of example in the surface section 12a, which is arranged opposite the optical receiver 38. Alternatively or additionally, a discontinuity can also be present in the transition region between the surface section 12b arranged on the optical transmitter 42 and the section 12a.

Alternatively or additionally, a discontinuity 58 is arranged, for example, between or in the transition region of the surface sections 14a and 14b. By way of example, the surface 16 is also illustrated with a discontinuity 62, which, for example, due to different inclinations with respect to the substrate 44 and/or the normal vector 46, can be used to implement different deflection angles within the lens module 20.

In the illustrated embodiment, the surface 14 thus has the discontinuous surface shape in a transition between the surface sections 14a and 14b. Alternatively or additionally, a discontinuity can also be arranged within a surface section 14a and/or 14b. The same applies to the surface 16, in which a discontinuous surface shape can be formed both between the surface sections 16a and 16b and alternatively or additionally within the surface section 16a and/or the surface section 16b.

As is indicated in the schematic side sectional view of FIG. 2, in analogy to the lens module 10, some of the surface sections are arranged so as to enclose one another and surface sections are arranged laterally next to one another in other surfaces. Depending on the implementation, the respective configuration is freely selectable, but it is of advantage in particular with respect to rotation about the axis of rotation 54 for the surface section 14b to be arranged so as to enclose the surface section 14a in the surface 14 and/or for the surface section 16b to be arranged so as to enclose the surface section 16a of the surface 16. This can be combined particularly advantageously if the surface sections 12a and 12b are arranged laterally adjacent to each other.

It is particularly of advantage, in particular with respect to rotation about the axis of rotation 54, for the surface section 14a of the surface 14 to be formed to be rotationally symmetrical about the axis of rotation 54 and the surface section 14b of the surface 14 also to be formed to be rotationally symmetrical about the axis of rotation 54. In combination with the enclosing arrangement, this can mean, for example, a concentric arrangement of the surface sections 14a and 14b.

FIG. 2 shows, also with reference to the angle α between the normal vector 46 and the axis of rotation 54, that a advantageous configuration of a lens module described herein is that the surfaces 12 and 14 and the surface 16 are inclined with respect to one another at an angle in order to effect deflection of a main beam direction of the optical arrangement of the surface sections 12a, 14a and 16a on the one hand and/or of the optical arrangement comprising the surface sections 12b, 14b and 16b on the other hand by 90° within a tolerance range of +30°, +20° or +10°, advantageously less.

The respective optical arrangements comprising the surface sections 12a, 14a and 16a on the one hand and 12b, 14b and 16b on the other hand can each be used for arrangement-specific beam shaping of incident or exiting optical-wireless signals and form a respective optical channel. Such independent beam shaping can be used, for example, to collimate an exiting beam path as far as possible while an incident beam is focused onto an optical receiver. If, for example, several optical receivers are used, different surface sections can be adapted to the local differences of the lens module and set for the same function, for example focusing. If, for example, several optical transmitters are used, a respective section or optical channel can be configured such that the lens module transmits several collimated output signals which are as disjoint as possible.

It is of advantage here if the different optical channels are substantially free of channel crosstalk, for example by a maximum of 1%, a maximum of 0.1%, a maximum of 0.01% of the optical power of the respective channel or less crosstalk into the respective other optical channel. In this case, crosstalk is understood as incidence of a part of a first transmitting signal 52 on the respective other photodetector in addition to a second receiving beam 49, which also takes into account the angle of acceptance of the surface sections used for the reception and internal crosstalk due to Fresnel reflections. Although the passage of light by itself can be problem-free, quality losses can occur at the location of the respective optical receiver, which is why channel crosstalk is advantageously avoided.

For this purpose, the lens module 10 and/or the lens module 20 provides a good starting position in that the optical channels at the surfaces 12, 14 and 16 are arranged to be locally disjoint from one another by means of the respective different surface sections 12a, 12b; 14a, 14b and 16a, 16b.

Although the lens modules 10 and 20 are described such that the respective surfaces 12, 14 and 16 have exactly two surface sections, further embodiments provide lens modules in which each of the surfaces 12, 14 and 16 has more than two surface sections, that is at least a third and possibly a fourth or more surface sections. As a result, an even higher number of optical channels can be shaped and deflected by the same lens module.

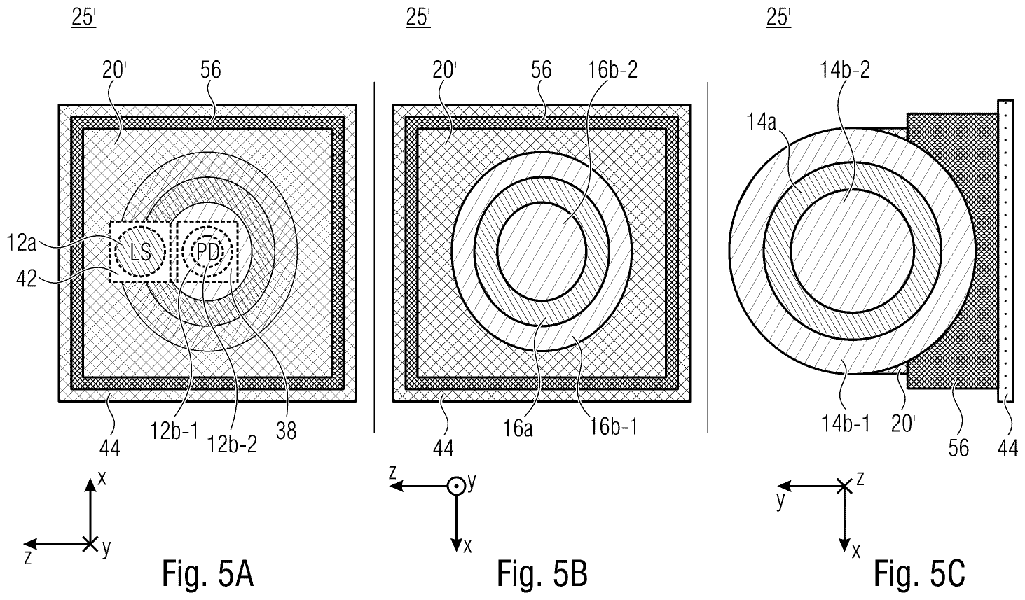

It is to be pointed out at this point that it is possible but not necessary for all optical channels to be formed with an identical number of, for example, one surface section at each of the surfaces 12, 14 and 16. According to other embodiments, it is possible for optical channels to have, independently of one another, a number of surface sections differing from other surfaces and/or other optical channels, in at least one of the surfaces 12, 14 and/or 16. Examples are discussed in FIGS. 5A-C, 6A-C and 7. Returning to FIG. 1 and FIG. 2, the lens modules 10 and 20 are described such that the number of the respective surface sections which are locally contiguous is identical. Other embodiments relate to the fact that, in particular, the surface section 14b of the surface 14 can comprise several locally disjoint sub-regions, which will be discussed in detail later.

Like other lens modules described herein, the lens module 10 and/or 20 can be formed monolithically or integrally, which means that the implementation of joints or the like can be dispensed with. For example, lens modules described herein are ground, milled or cast from a transparent material. An advantageous material for the formation of lens modules described herein is a plastic material. Plastic materials are advantageous here which can be referred to as high-temperature plastic and, for example, support a reflow process. This means that an overall structure, part of which the lens module can be, can be heated to a temperature at which a solder material, for instance comprising tin or the like, is liquefied in order to form stable solder joints after cooling. Allowing the reflow process means that the lens module experiences no or negligible impairment of the optical quality during this process, as would occur, for example, by melting surfaces and/or by deformation. For example, the Sabic EXTEM™ material is suitable for a reflow process and for lens modules described herein.

In other words, embodiments provide for integrating transmission optics comprising the surface subregions 12a, 14a and 16a and reception optics comprising the surface subregions 12b, 14b and 16b into one another such that a single, complex transceiver optics is produced, the lens module 10 and/or 20 or other lens modules described herein. For example, FIG. 2 shows a sectional representation through such a transceiver or a portion thereof. The transceiver optics 20 is connected to a substrate 44 via a holding structure 56. The electrical components are arranged on this substrate. These comprise a transmission element 42 and a reception element 38.

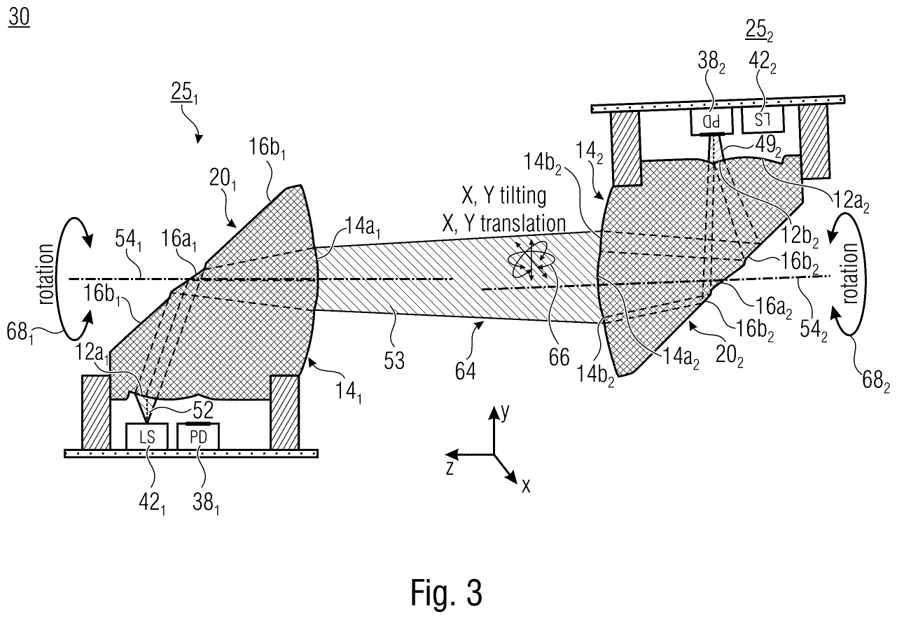

In further other words, the complex transceiver optics 20 can integrate both the transmission optics 12a, 14a, 16a and reception optics 12b, 14b, 16b, wherein each can comprise its own optically active surfaces. The beam shaping and beam guidance consists of or at least comprises two optically refractive boundary surfaces 12a, 12b on the one hand and 14a, 14b on the other hand and a reflective surface 16a, 16b arranged therebetween. The two first optically refractive boundary surfaces 12a, 12b form at least parts of the input surface 12 of the complex optics. The two reflective surfaces 16a, 16b form the deflection surface 16 of the complex optics at least partially. The two second optically refractive boundary surfaces 14a, 14b form the output surface 14 of the complex optics at least partially. Thus, the optical surfaces 12a, 12b, 14a, 14b are arranged such that they can emit (12a, 14a) a transmitting beam 52/53 symmetrically to the axis of rotation 54 and receive (12b, 14b) a receiving beam 48/49, respectively. Thus, an output beam 52 of a first transceiver becomes the receiving beam of another, second transceiver. The same applies in the reverse direction for a bidirectional, rotatable transceiver link, which is described in more detail in connection with FIG. 3. Due to the compact transceiver optics, the rotatability for a 360° rotation can be made possible even at very short distances.

Thus, the axis of rotation 54 is tilted by an angle α about the normal vector 46 of the transceiver substrate 44. This angle is advantageously in the range of 0<<α<<180°. For such a consideration, it is assumed that the transceiver substrate 44 is substantially planar. If this is not the case, the deflection angle relates to the respective main transmission/main reception axes. A deviation from this is also possible, but is not advantageous from a manufacturing and design point of view. In the illustration of FIG. 2, an angle of 90° is shown by way of example. This present embodiment of the invention allows communication tangential to the substrate surface or circuit board on which the transceiver was placed, without the transceiver itself having to be placed obliquely on the circuit board. Such a structure can manage without additional mirrors. Depending on the choice of the angle α, however, a different direction can also be implemented.

FIGS. 1 and 2 thus show exemplary illustrations of a lens module or, in the case of FIG. 2, of such a transceiver. Such a transceiver can consist of several mutually independent transmitting optics 12a, 14a, 16a and/or receiving optics 12b, 14b, 16b. These can then be arranged adjacent to each other in the complex transceiver optics and each have the two optically refractive boundary surfaces as partial surfaces of the surfaces 12, 14 and a reflective boundary surface, arranged therebetween, as a surface subregion of the surface 16.

According to an embodiment, m transmission elements or reception elements 38, 42 are associated to these n multiple transmitting optics or receiving optics 12, 14. Preferably 1≤m≤n applies, wherein n≥1. At least one transmitting optics 12a, 14a, 16a consisting of two optically refractive boundary surfaces 12a, 14a and the reflective boundary surface 16a arranged therebetween in the beam path are thus associated to each transmission element. Likewise, at least one receiving optics 12b, 14b, 16b comprising two optically refractive boundary surfaces 12b, 14b and the reflective boundary surface 16b arranged therebetween in the beam path are associated to each receiving element 38. The number of associated optics between transmission element and receiving element can also differ from this. For example, it can be expedient to divide the transmitting optics into several parts in order to divide the entire output power into several parts and thus to improve the eye safety of an optical transceiver in which the output surfaces are arranged at distributed points of the output surface. Preferably, a symmetrical distribution about the axis of rotation 54 is to be ensured in order to obtain the rotatability of the transceiver, for example in that a transmitting beam always impinges on an optical receiver.

The embodiment explained above relates to an advantageous implementation. Deviating from this, however, it is readily possible to assign only one transmitting optics to two or more transmission elements and/or to assign only one receiving optics to two or more reception elements. The electrical complexity is increased with such an implementation, which possibly counteracts the optimization goal in an optimization of the system design towards a simple system; however, it allows the use or the achievement of higher transmission powers, which is advantageous, for example, for achieving high transmission paths, for which the increase in complexity acceptable.

In FIG. 2, the electrical receiver element 38 is arranged adjacent to the electrical transmission element 42 on the carrier 44. The electrical receiver element 38 can comprise, for example, a PIN diode, an avalanche diode, a metal-semiconductor-metal diode or the like. The electrical transmission element 42 can comprise, for example, a laser diode LD, a light-emitting diode (LED). The wavelength can be in any wavelength range, advantageously in an ultraviolet wavelength range, in a visible wavelength range and/or in an infrared wavelength range.

As illustrated in FIG. 2, an optical-wireless transceiver in accordance with embodiments has a lens module described herein as well as an optical receiver 38 and an optical transmitter 42. The optical receiver 38 is aligned with the partial surface region 12b of the first surface 12 and is configured to receive a first optical-wireless signal 48, which arrives at the partial surface region 14b of the surface 14, from the partial surface region 14b of the surface 14. The optical transmitter 42 is aligned with the partial surface region 12a of the surface 12 and is configured to transmit the second optical-wireless signal 52 to the first partial surface region 12a of the surface 12. The lens module is configured to direct and shape the optical-wireless signal 52 onto the partial surface region 14a of the surface 14.

In other words, FIG. 2 shows a basic setup of the transceiver with beam guidance of the output beam 52 towards the transmitting beam 53 as well as beam guidance of an incident transmitting beam 48 towards the receiving beam 49 onto the detector 38.

FIG. 3 shows a schematic side sectional view of an optical-wireless system with two optical-wireless transceivers 25₁ and 25₂ which are configured and aligned for mutual communication. Each of the optical-wireless transceivers 25₁ and 25₂ can be formed as a transceiver according to FIG. 2, wherein other optical-wireless transceivers having lens modules described herein can also be used.

The reception of the optical signal 52 or 53 emitted by the optical-wireless transceiver 25₁ at the optical-wireless transceiver 25₂ is illustrated by way of example. As long as a light cone 64 of the shaped signal 53 impinges on at least parts of the surface section 14b₂ of the transceiver 25₂, a corresponding light portion can be directed onto an optical receiver 38₂ of the optical-wireless transceiver 25₂. Here, the advantageous implementation of the lens module comes into play, according to which surface sections which are associated to the reception of an optical-wireless signal are arranged so as to enclose a surface section of the surface 14 which is used for transmission. The increasing divergence of the beam bundle can thus be utilized well on the receiver side.

In the optical-wireless system 30, for example, both optical-wireless transceivers 25₁ and 25₂ are mounted rotationally about rotation axes 54₁ and 54₂. For example, the optical-wireless transceiver 25₁ is configured to perform a rotation 681 about the rotation axis 541, which can correspond to a transmission main direction along which the optical-wireless signal 53 is transmitted through the side 14 of the lens module 201. Alternatively or additionally, the optical-wireless transceiver 25₂ can be configured to perform a rotation 68₂ with respect to the optical-wireless transceiver 25₁ about a transmission main direction, which can correspond to the rotation axis 54₂ and along which the transmission signal of the optical-wireless transceiver 25₂ can be emitted. It is to be noted that the rotation axis can also be tilted with respect to a main transmission direction and/or main reception direction, i.e., the rotations can be effected on a parallel or congruent axis, but the transmission directions and/or reception directions can deviate from one another.

The rotation axis 54₁, about which the optical-wireless transceiver 25₁ can be rotatable, is arranged, for example, parallel to a z-direction in space. Tilting and/or displacement 66 of the rotation axis 54₂ of the optical-wireless transceiver 25₂ along and/or about an x-axis and/or y-axis can be tolerated as long as the respective signal to be received still impinges on the lens module within the receiving angle of the respective receiver lens.

Although the optical-wireless transmitter/receiver pairs 42₁ and 38₂ or 42₂ and 38₁ do not have to be directed toward each other, the corresponding optical-wireless signals can be deflected correspondingly by the directional deflection by means of the lens modules 20₁ and 20₂, wherein it is of advantage for the sides 14₁ and 14₂ to be arranged facing each other, which does not exclude tilting and/or displacement 66.

The optical-wireless system 30 can be configured for full-duplex communication between the optical-wireless transceivers 25₁ and 25₂. Due to the spatial separation of the respective transmitting signal and receiving signal, interference-free communication operation can be maintained even if both optical-wireless transceivers 25₁ and 25₂ transmit simultaneously. It comes into play here that the lens modules 20₁ and 20₂ can be configured for optical separation of opposite optical-wireless signals.

It is to be noted that the rotation 68₁ and 68₂ is considered to be advantageous, but that only one of the two components can also easily be arranged to be rotational with respect to the other, possibly stationary component. It is also to be noted that the advantages according to the invention of directional deflection and optical separation can also be utilized if both transceivers 25₁ and 25₂ are stationary or at least do not rotate.

In other words, FIG. 3 shows a complete data link by way of example. A first transceiver 25₁ transmits the beam shifted onto the axis of rotation 54₁ of the first transceiver 25₁ in the direction of a second transceiver 25₂. The transmitting beam is focused by the second transceiver 25₂ by means of the receiving optics 14b₂, 16b₂, 12b₂ onto the electrical receiver element 38₂. Thus, the two transceivers can be tilted with respect to each other and/or displaced with respect to each other within a certain range, as shown by the displacement (or translation)/tilting 66. As a result, the transceiver 25₂ is caused to have a second axis of rotation 54₂. The region of the second transmitting surface 12a₂, 16a₂, 14a₂ will not be used for focusing. During data transmission, one or both transceivers 25₁ and/or 25₂ can be permanently rotated with respect to each other.

In further other words, FIG. 3 shows a complex data link consisting of two transceivers. A transmission direction is shown here exemplarily. An exemplary tilting as well as translation is illustrated combinatorially with reference numeral 66.

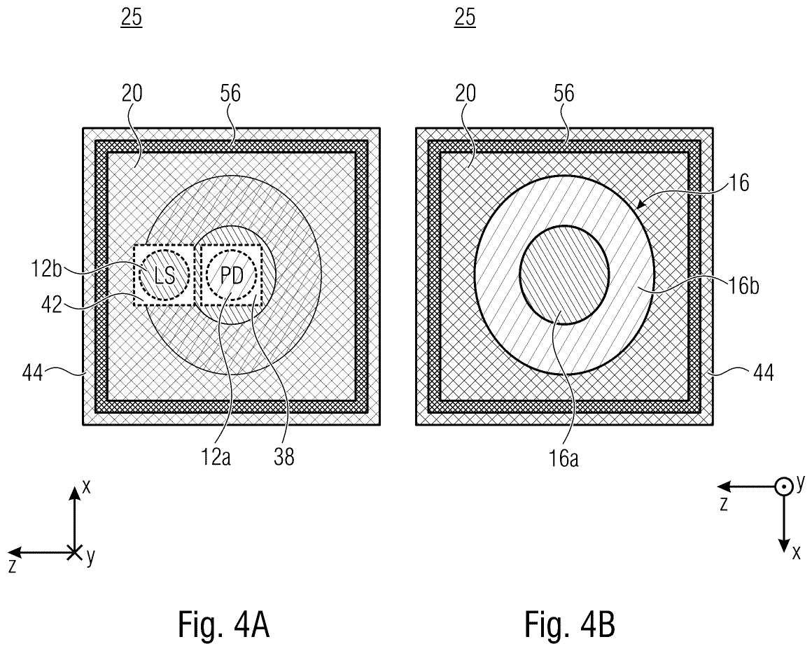

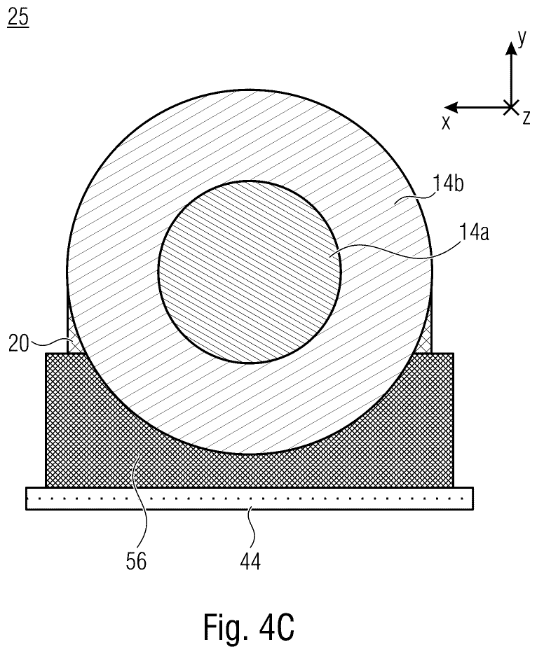

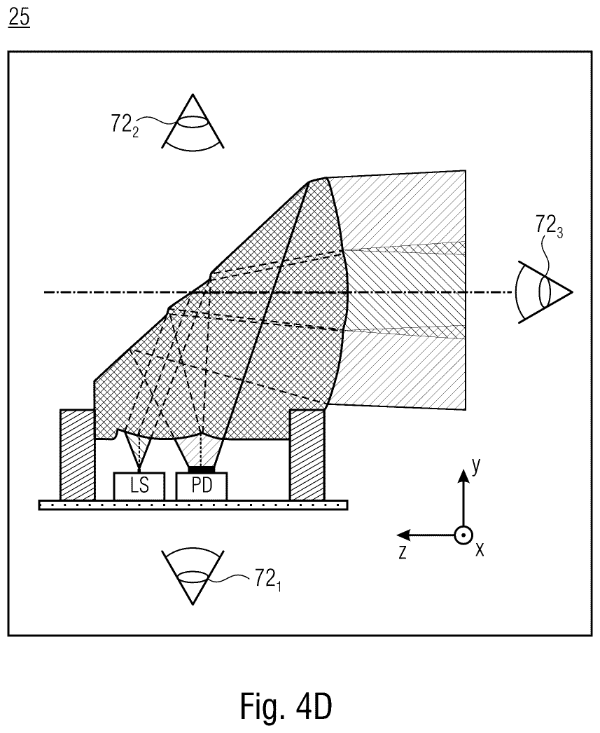

FIGS. 4A-C show schematic views of the optical-wireless transceiver 25 from FIG. 2. For better clarity, FIG. 4D shows a comparison of different viewing directions or viewing positions 72₁, 72₂ and 72₃ on the transceiver 25, wherein the viewing direction 72₁ is illustrated in FIG. 4A, the viewing direction 72₂ in FIG. 4B and the viewing direction 72₃ in FIG. 4C. In FIGS. 4B and 4c, the enclosing arrangement of the surface section 16b around the surface section 16a and of the surface section 14b around the surface section 14a is illustrated, while in FIG. 4A the laterally adjacent arrangement of the surface sections 12a and 12b is clearly visible.

In other words, FIG. 4A shows a bottom view, wherein the substrate 44 is indicated exemplarily only at the edge. The transmission element 42 and the reception element 38 with the complex optics 20 arranged above and the holding structure 56 are visible. The first optically refractive boundary surface 12a of the transmitting optics and the first optically refractive boundary surface 12b of the receiving optics are highlighted.

FIG. 4B shows a top view, in which the complex optics 20, the holding structure 56 and the substrate 44 are shown. The reflectively configured optical boundary surface of the transmitting optics 16a and the reflective optical boundary surface of the receiving optics 16b are highlighted.

FIG. 4C shows a front view, in which the complex optics 20, the holding structure 56 and the substrate 44 are shown. The second optically refractive boundary surface 14a of the transmitting optics and the second optically refractive boundary surface 14b of the receiving optics are highlighted.

In other words, FIGS. 4A-D show exemplarily top views of the respective optical boundary surfaces of the embodiment shown in FIG. 2, in order to illustrate the configuration thereof. FIGS. 4A-C in this case show top views of the optical boundary surfaces of a first embodiment with transmitting optics and receiving optics.

FIGS. 5A-C show views, comparable to FIGS. 4A-C, of an optical-wireless transceiver 25′, in which two receiving optics 12b-1, 16b-1 and 14b-1 on the one hand and 12b-2, 16b-2 and 14b-2 on the other hand are associated to the optical receiver 38. In other words, the receiving optics can be divided in two with respect to the lens module 20. A higher division into more than two elements is also conceivable. In the case illustrated, the transmitting optics is placed by way of example as a circular ring element 16a or 14a between the two receiver regions 16b-1 and 16b-2 and 14b-1 and 14b-2. It is easily conceivable for a separate optical receiver to be associated to each receiving optics. This can be adjusted without any problems via a corresponding deflection on the surface 16. In other words, FIGS. 5A-C show exemplary top views of the respective optical boundary surfaces of a further embodiment with transmitting optics and two receiving optics.

In other words, FIGS. 5A-C show top views of the optical boundary surfaces of a second embodiment with transmitting optics and two receiving optics.

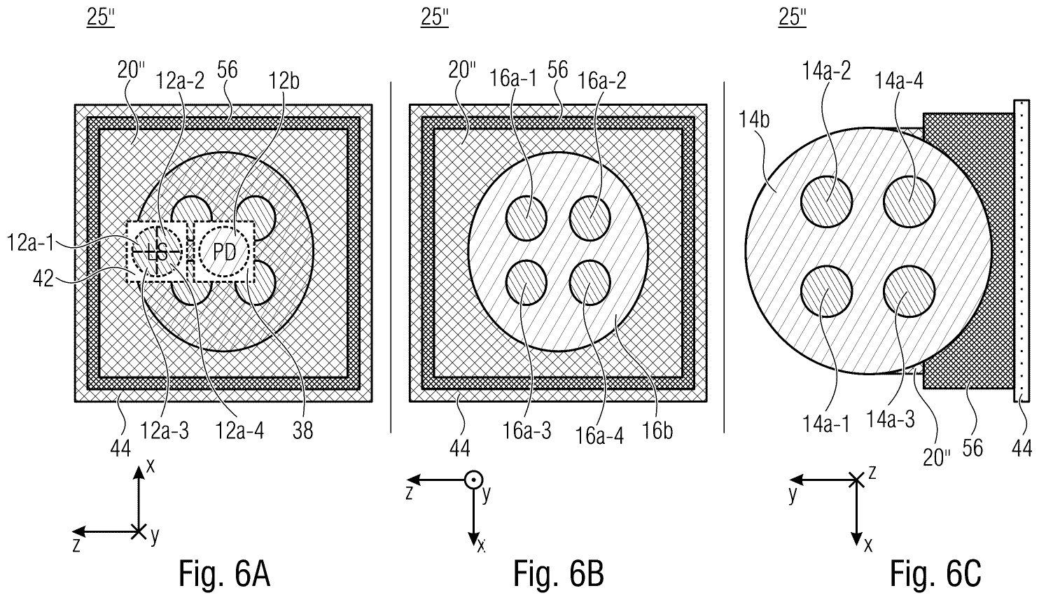

FIGS. 6A-C show illustrations, comparable to FIGS. 4A-C and 5A-C, of an optical-wireless transceiver 25″, which has a lens module 20″, which allows a transmission signal to be divided into a plurality of partial signals compared to the embodiments of FIGS. 5A-C. While the lens module 20′ arranged in the optical-wireless transceiver 25′ can be formed such that the surface section 14b of the surface 14 and/or the surface section 16b of the surface 16 is divided into several locally disjoint and spaced-apart sub-regions 14b-1, 14b-2 or 16b-1 and 16b-2, the surface sections 14a of the surface 14 and 16a of the surface 16 can be divided in the case of FIGS. 6A-C, wherein the number of four sub-regions 14a-1-14a-4 and 16a-1-16a-4 is selected exemplarily. Even if the number of the sub-regions in the respective surface sections 14a and 16a is advantageously identical, the number of four is, for example, one, as in the lens module 10 or 20, two, three or more than four.

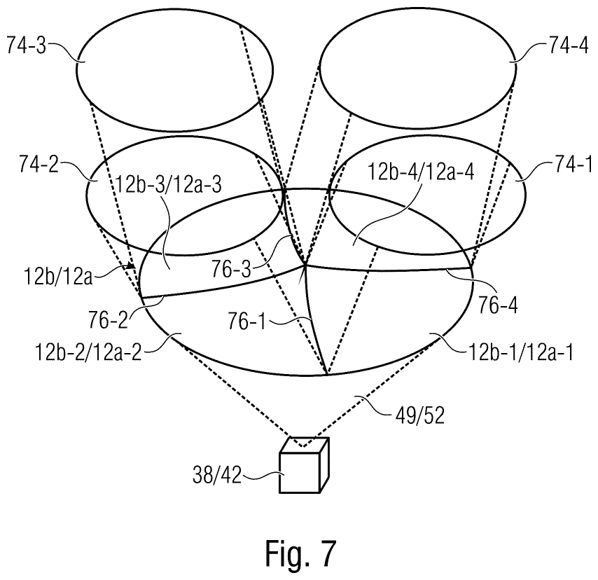

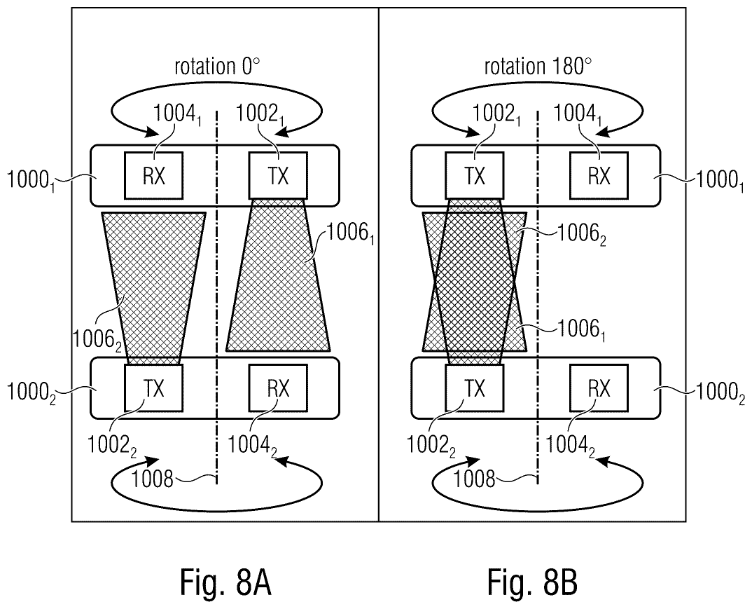

The surface section 12a can be formed to be contiguous or also be divided into disjoint sub-regions. In particular in an implementation in which the surface section 12a of the surface 12 is formed to be contiguous, it is of advantage for the surface section 16a of the surface 16 to be formed to transform an optical signal between the contiguous surface section 12a of the surface 12 and the locally disjoint sub-regions 14a-1-14a-4 of the surface 14. This means, for example, dividing in the transmission case, wherein, with reference to FIGS. 5A-C, merging of disjoint sub-signals can be carried out correspondingly in the reception case. In other words, a contiguous but not continuous surface can be used or is even required for the division. In the case of four sub-beams, there can be quarter surfaces with four discontinuous regions each, as is illustrated by way of example referring to FIG. 7.

With reference to FIGS. 6A-C, exemplary top views of the respective optical boundary surfaces of a further embodiment with four transmitting optics 12a-1-12a-4, 14a-1-14a-4 and 16a-1-16a-4 and receiving optics 12b, 14b, 16b are shown there. Thus, four transmitting optics are associated to the transmitting unit 42 or the transmitting beam is split or divided into four segments at the surface 12a. This means that several transmission elements can be used and/or a transmission beam can be divided. The reflective surfaces 16a-1-16a-4 and/or the refractive surfaces 14a-1-14a-4 can each be arranged within the receiving surfaces 14, 16. The shape of the surfaces in the drawings illustrated in the embodiments shown here is to be understood to be exemplary. The area of use can influence the actual configuration. In principle, any possible geometric surface shapes and/or free shapes are possible. The respective complexity or the readiness to spend corresponding efforts can pose a limit here.

In other words, FIGS. 6A-C show top views of the optical boundary surface of a third embodiment with four transmitting optics and one receiving optics.

FIG. 7 shows a schematic perspective illustration of a mode of operation of a beam-dividing or beam-merging surface or partial surface region 12a or 12b, which shows that the optical mode of operation is reversible with respect to its direction. Thus, for example, the optical receiver 38 can be used just like the optical transmitter 42. The respectively associated partial surface regions 12b-1 to 12b-4 or 12a-1 to 12a-4 can be connected to adjacent regions by means of discontinuity 76-1 to 76-4, for instance in order to join different curvatures together.

The illustrated dividing surface here can be arranged in the surface 12 and/or in the surface 14. Both are conceivable. Such a division can alternatively or additionally also be implemented in the deflection surface, the surface 16.

Merging or division by means of the surface 16 can then be performed such that one of the two surface sections 12a or 12b or 14a or 14b of one of the two surfaces 12 or 14 is formed to be contiguous and the associated surface section of the other surface is divided into several, i.e. at least two, locally disjoint sub-regions. The associated surface section of the third surface 16 is configured to transform, i.e. divide or merge, the optical signal between the associated contiguous surface section and the associated locally disjoint sub-regions of the other surface section.

Even if embodiments described herein consider the case of a rotation, rotatability is not absolutely necessary even when utilizing the deflection of optical-wireless signals tangential to the circuit board surface; nevertheless, a compact setup can be benefit from by integrating transmitting optics, receiving optics with the respectively integrated deflection surface. Furthermore, remote controls for an optical-wireless remote control of devices can be considered, for example. In this case, for example, the PCB lies flat in the hand and radiation perpendicularly to the PCB normal is desired. In many cases, it is dependent on the integration of the overall electronics in the final product in which direction signals are to be emitted or from which direction signals are to be received. In the concept described herein, the radiating angle, for example referred to as angle α in FIG. 2, can be set in a variable but defined manner.

Although some aspects have been described in connection with an apparatus, it is understood that these aspects also represent a description of the corresponding method so that a block or a component of an apparatus is also to be understood as a corresponding method step or as a feature of a method step. Analogously thereto, aspects which have been described in connection with or as a method step also represent a description of a corresponding block or detail or feature of a corresponding apparatus.

Depending on certain implementation requirements, embodiments of the invention can be implemented in hardware or in software. The implementation can be carried out using a digital storage medium, for example a floppy disk, a DVD, a Blu-ray disc, a CD, ROM, PROM, EPROM, EEPROM or a FLASH memory, a hard disk or another magnetic or optical memory on which electronically readable control signals are stored which are able to interact or interact with a programmable computer system such that the respective method is carried out. Therefore, the digital storage medium can be computer-readable. Some embodiments according to the invention thus comprise a data carrier which has electronically readable control signals which are able to interact with a programmable computer system such that one of the methods described herein is carried out.

In general, embodiments of the present invention can be implemented as a computer program product having program code, wherein the program code is effective to carry out one of the methods when the computer program product runs on a computer. The program code can also be stored on a machine-readable carrier, for example.

Other embodiments comprise the computer program for carrying out one of the methods described herein, wherein the computer program is stored on a machine-readable carrier.

In other words, an embodiment of the method according to the invention is thus a computer program which has program code for carrying out one of the methods described herein when the computer program runs on a computer. A further embodiment of the methods according to the invention is thus a data carrier (or a digital storage medium or a computer-readable medium) on which the computer program for carrying out one of the methods described herein is recorded.

A further embodiment of the method according to the invention is thus a data stream or a sequence of signals which represents or represent the computer program for carrying out one of the methods described herein. The data stream or the sequence of signals can be configured, for example, to be transferred via a data communication connection, for example via the Internet.

A further embodiment comprises a processing device, for example a computer or a programmable logic component, configured or adapted to carry out one of the methods described herein.

A further embodiment comprises a computer on which the computer program for carrying out one of the methods described herein is installed.

In some embodiments, a programmable logic component (for example a field-programmable gate array, FPGA) can be used to carry out some or all of the functionalities of the methods described herein. In some embodiments, a field-programmable gate array can interact with a microprocessor in order to carry out one of the methods described herein. Generally, in some embodiments the methods are carried out by any hardware device. This can be universally usable hardware such as a computer processor (CPU) or hardware specific to the method, such as an ASIC, for example.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A lens module comprising a first surface and a second surface inclined relative to the first surface, which are optically coupled to each other via a third surface inclined relative to the first surface and the second surface;
wherein each of the first surface, the second surface and the third surface comprises a first surface section and a second surface section; wherein the first surface sections are associated to one another; and wherein the second surface sections are associated to one another, and form a respective optical arrangement.

2. The lens module according to claim 1, which is configured to provide a light exit from the first surface section of the second surface on the basis of a light entry at the first surface section of the first surface by means of total reflection at the first surface section of the third surface, or vice versa; and/or
to provide a light exit from the second surface section of the second surface on the basis of a light entry at the second surface section of the first surface by means of total reflection at the second surface section of the third surface, or vice versa.

3. The lens module according to claim 1, wherein the first surface is a combinatorial lens surface of a first and a second lens; and the second surface is a combinatorial lens surface of the first and second lens; and the third surface is a combinatorial deflection surface, for example a reflection surface, of the first and second lens.

4. The lens module according to claim 1, wherein the first surface comprises a discontinuous surface shape in a transition region between the first surface section and the second surface section or within the first or second surface section; and/or
wherein the second surface comprises a discontinuous surface shape in a transition between the first surface section and the second surface section or within the first or second surface section; and/or
wherein the third surface comprises a discontinuous surface shape in a transition between the first surface section and the second surface section or within the first or second surface section.

5. The lens module according to claim 1, wherein the second surface section of the first surface is arranged laterally adjacent to the first surface section of the first surface.

6. The lens module according to claim 1, wherein the second surface section of the second surface is arranged so as to enclose the first surface section of the second surface.

7. The lens module according to claim 1, wherein the second surface section of the third surface is arranged so as to enclose the first surface section of the third surface; or
wherein the first surface section of the second surface is formed to be essentially rotationally symmetrical about an axis of rotation and the second surface section of the second surface is formed to be rotationally symmetrical about the axis of rotation; or
a free-form surface.

8. The lens module according to claim 1, wherein the first surface, the second surface and the third surface are inclined with respect to one another in order to effect deflection of a main beam direction of a first optical arrangement of the lens module.

9. The lens module according to claim 1, wherein the first surface sections of the first surface, the second surface and the third surface form a first optical arrangement for first beam shaping for a first optical channel; and wherein the second surface sections of the first surface, the second surface and the third surface form a second optical arrangement for a second beam shaping for a second optical channel; wherein the first beam shaping is independent of the second beam shaping.

10. The lens module according to claim 9, wherein the first optical channel and the second optical channel are locally disjoint from each other at the first surface, the second surface and the third surface by means of the first surface sections and the second surface sections.

11. The lens module according to claim 1, wherein the second surface section of the first surface is formed to be contiguous; and the second surface section of the second surface comprises several locally disjoint sub-regions; wherein the second surface section of the third surface is configured to transform an optical signal between the contiguous second surface section of the first surface and the locally disjoint sub-regions of the second surface section of the second surface.

12. The lens module according to claim 1, wherein each of the first surface, the second surface and the third surface comprises at least one respective third surface section; and the lens module effects individual beam shaping of at least three optical channels.

13. The lens module according to claim 1, which is formed monolithically or integrally.

14. The lens module according to claim 1, which is formed comprising a plastic material, advantageously a high-temperature plastic, which supports a reflow process, in particular a Sabic EXTIT™ material.

15. An optical-wireless transceiver comprising:
a lens module comprising a first surface and a second surface inclined relative to the first surface, which are optically coupled to each other via a third surface inclined relative to the first surface and the second surface,
wherein each of the first surface, the second surface and the third surface comprises a first surface section and a second surface section; wherein the first surface sections are associated to one another; and wherein the second surface sections are associated to one another, and form a respective optical arrangement;
an optical receiver aligned with the second partial surface region of the first surface; and configured to receive a first optical-wireless signal, which arrives at the second partial surface region of the second surface, from the second partial surface region of the first surface; and
an optical transmitter aligned with the first partial surface region of the first surface; and configured to transmit a second optical-wireless signal to the first partial surface region of the first surface; and the lens module is configured to direct and shape the second optical-wireless signal onto the first partial surface region of the second surface.

16. The optical-wireless transceiver according to claim 15, wherein the optical receiver and the optical transmitter are arranged on a common substrate; and the optical-wireless transceiver comprises a holding structure, which is arranged on the substrate; and configured to hold the lens module relative to the optical receiver and the optical transmitter.

17. The optical-wireless transceiver according to claim 15, wherein a main reception direction for receiving the first optical signal and a transmission direction, which describes a main emission direction of the emitted second optical-wireless signal, are parallel to each other.

18. An optical-wireless system comprising:
a first optical-wireless transceiver according to claim 15, configured to receive the first optical-wireless signal and to transmit the second optical-wireless signal; and
a second optical-wireless transceiver according to claim 15, configured to receive the second optical-wireless signal and to transmit the first optical-wireless signal.

19. The optical-wireless system according to claim 18, wherein the first optical-wireless transceiver is configured to perform a rotation relative to the second optical-wireless transceiver about a transmission main direction along which the second optical-wireless signal is transmitted through the second side of the first lens module; and/or
wherein the second optical-wireless transceiver is configured to perform a rotation relative to the first optical-wireless transceiver about a transmission main direction along which the first optical-wireless signal is transmitted through the second side of the second lens module.

20. The optical-wireless system according to claim 18, which is configured for full-duplex communication between the first optical-wireless transceiver and the second optical-wireless transceiver; wherein the lens modules of the optical-wireless transceivers are configured for optical separation of opposite optical-wireless signals.
